(19) United States
(12) Patent Application Publication
(10) Pub. No.: US 2006/0170709 A1
(43) Pub. Date: Aug. 3, 2006

(54) Image realignment apparatus and a method thereof

(75) Inventor: Wei-Hsin Tseng, Hsintien City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Cyberlink Corp.

(21) Appl. No.: 11/137,828

(22) Filed: May 25, 2005

(30) Foreign Application Priority Data
Feb. 1, 2005 (TW) 94103061

(51) Int. Cl. G09G 5/00

(52) U.S. Cl. 345/649

(57) ABSTRACT

An image realignment apparatus and a method thereof are disclosed. The method includes judging whether an image feature, such as the facial feature in an image, is facing upwards by using a feature identification algorithm, wherein the image and the feature identification algorithm are stored in an image acquisition apparatus or a computer. Moreover, the method can automatically realign an image in order to obtain a correct display of the image, if the image feature is not facing upwards. Furthermore, the method firstly judges the image features and then rotates the image, or firstly rotates the image and then judges whether the image features are facing upwards. Whereby, the rotating step and the judging step are repeated until the image features are facing upwards so as to display the image correctly.

### BACKGROUND OF THE INVENTION

1. Field of the Invention

The present invention relates to an image realignment apparatus and a method thereof, and particularly relates to an image realignment apparatus comprising a feature identification algorithm stored in a digital image acquisition apparatus or on a computer. The method can automatically realign an image in order that it may be viewed as the person who took the picture intended it to be viewed.

2. Description of Related Art

When using a camera, users usually shoot a picture at an angle of 90 degrees or 180 degrees when taking pictures of people or scenery. However, the user must often realign an image when viewing it in a storage medium apparatus such as a computer, otherwise it is inconvenient for the user to view the image. Hence, an image often needs to be realigned by the user himself/herself. This is a time-consuming and laborious process, especially when there are a large number of images.

FIG. 1 shows a schematic view of an operation method for the related art. The digital image is transmitted from a digital image capturing apparatus 14 to a computer 10 by a communication line for viewing. When the person, such as an image 12, is shown at a 90-degree angle, the user can rotate the image 12 either clockwise or anticlockwise via the rotation software 18 of the computer program, wherein the rotation includes a left rotation or a right rotation.

FIG. 2 shows a flowchart for an operating method of the related art. The method of the related art includes the sets of: firstly, loading an image file (step S21) from the digital image capturing apparatus or the storage medium apparatus; afterwards, judging whether the image needs to be realigned when the user views the image (step S22); and then, if the image does not need to be realigned, finishing the flowchart of the method, or, if the image needs to be realigned, the user must manually realign the image by using image processing software (step S23).

As a result, it is inconvenient for user to manually rotate an image for viewing with the image processing software. Moreover, it is time-consuming and laborious to individually realign so many images that may be stored in the storage medium apparatus. Hence the present invention provides a method for an image realignment apparatus that judges, based upon the features of an image and via a feature identification algorithm, whether the image needs to be realigned so that it may be viewed as the person who took the photo intended it to be viewed.

### SUMMARY OF THE INVENTION

The present invention provides an image realignment apparatus and a method thereof. The image realignment apparatus comprises a feature identification algorithm that is used to judge whether an image features, such as a face or scenery, is facing upward. Moreover, the method can automatically realign a landscape image in order to obtain a portrait image, if the direction of the image feature does not face upward.

One aspect of the invention is an image realignment apparatus. The image realignment apparatus comprises a loading unit, a memory unit and a microprocessor. The loading unit is used to load an image. The memory unit is used to store at least one feature identification algorithm and the image. The microprocessor is used to detect at least one image feature from the image according to the feature identification algorithm. It then judges whether the image is facing upwards, and, if it is not facing upwards, rotates the image until the image is facing upwards.

Further aspects of the invention are two methods for automatically rotating images. One of the methods comprises the steps of: a loading step for loading an image; a detecting step for detecting at least one image feature of the image; a judging step for judging whether the image feature is facing upwards; and a rotating step for rotating the image until the image feature is facing upwards.

The other method comprises the steps of: a loading step for loading an image; a rotating step, for rotating the image; a detecting step, for detecting at least one image feature of the image; and a judging step, for judging whether the image feature is facing upwards, wherein if the image feature is not facing upwards, returning to the rotating step for rotating the image until the image feature is facing upwards.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a schematic view of an operating method for the related art;

FIG. 2 is a flowchart of an operating method for the related art;

FIG. 3 is a schematic view of rotating an image;

FIG. 4 is a schematic view of an image realignment apparatus of the present invention;

FIG. 5 is a flowchart for a method of automatically rotating images according to the first embodiment of the present invention; and

FIG. 6 is a flowchart of a method for automatically rotating images according to the second embodiment of the present invention.

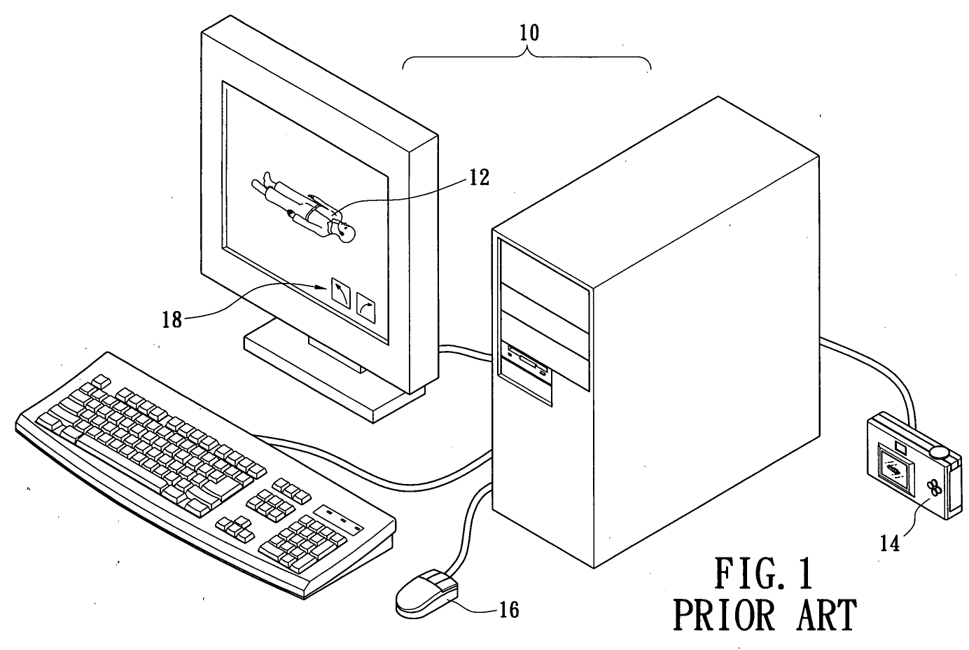

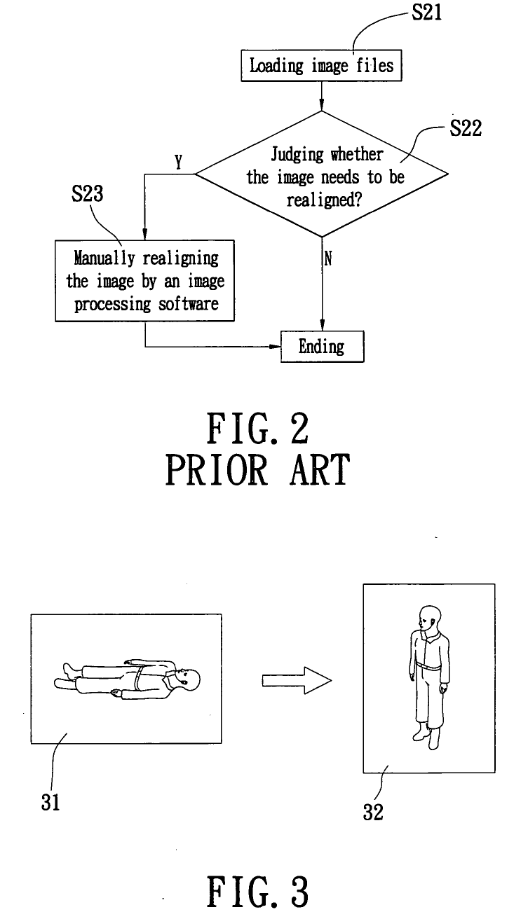

### DETAILED DESCRIPTION OF PREFERRED EMBODIMENTS

The present invention provides an image realignment apparatus and a method thereof. A feature identification algorithm is capable of judging an image feature from a digital image that is stored in a digital image acquisition apparatus or on a computer.

When the digital image is acquired from the image acquisition apparatus and is loaded onto the computer for viewing, it is possible that the digital image is not aligned correctly, at say a 90-degree angle, like a first image 31 of FIG. 3. The reason for the misaligned image is that a user shot the image 31 at a 180-degree angle rather than the conventional 90-degree angle. Once the image 31 has been loaded onto the computer however, the user must realign the image to make it viewable like a second image 32 of FIG. 3.

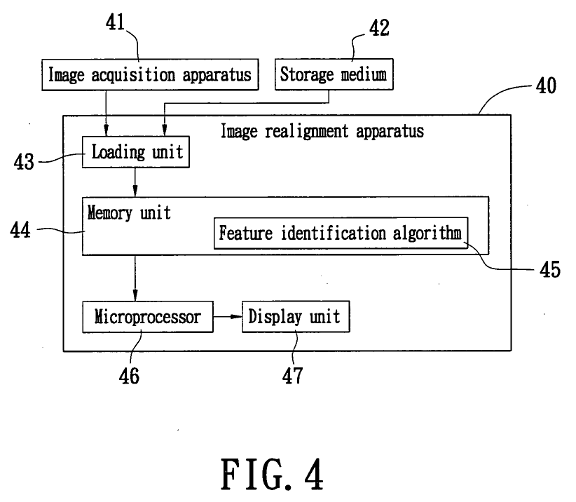

FIG. 4 shows a schematic view of an image realignment apparatus of the present invention. The image realignment apparatus can be installed inside an image acquisition apparatus such as a digital camera, or can be an image processing software/hardware that is installed on a computer. The image realignment apparatus at least comprises a loading unit 43, a memory unit 44 and a microprocessor 46. The loading unit 43 is used to load image files onto the image realignment apparatus from a digital image acquisition apparatus 41 or another storage medium 42 for providing an input/output interface to connect with another apparatus. After loading the image files, the image files are stored in the memory unit 44 that in communication with the microprocessor 46. The memory unit 44 has a feature identification algorithm 45, and is capable of storing the image files. The microprocessor 46 is used to detect the image feature (such as eyes, eyebrows, nostril, lips, ears and hair) from the image according to the feature identification algorithm 45 of the memory unit 44. When the microprocessor 46 judges that the image feature is not facing upwards, the image is rotated until the image feature is facing upwards.

The image realignment apparatus 40 further comprises a display unit 47 in communication with the microprocessor 46 to provide a preview of the image on the display unit 47 after the image has been rotated.

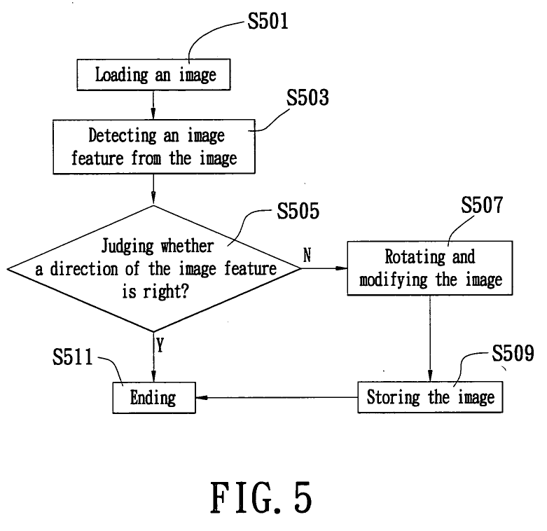

In order to automatically modify the direction of the image and further process most images, the present invention provides an image realignment apparatus and a method thereof. FIG. 5 shows a flowchart for a method of automatically rotating images according to the first embodiment of the present invention. The first embodiment only needs to execute the feature identification algorithm 45 to detect the image feature according to the image that is stored on the computer, the image acquisition apparatus or another non-volatile storage medium, then judges a rotation direction of the image based upon the image features, such as eyes, a facial features with a deep color such as a nose or a position relation between the nose and a mouth, or alternatively a direction of scenery with hills and water. In the best mode of the present invention the image feature can be selected from facial features, such as eyes, eyebrows, nostrils, lips, ears and hair. Finally, the judged direction is used to determine a realignment modification.

The method of the first embodiment is to judge whether a feature direction of the image file is correct, and, if it is not correct, to then do perform a realignment modification. The method comprises the steps of: firstly, loading an image or images from a storage medium such as a computer or an image acquisition apparatus (step S501); next, detecting at least one image feature from the image by the feature identification algorithm 45 (step S503), wherein the facial features of an image feature is the best mold; then judging whether the direction of the image feature is correct (step S505), wherein if the direction of the image feature such as the facial feature is correct, the image does not need to realign the image and the step of the realignment modification is finished (step S511); if the direction of the image feature is not correct, doing the realignment modification, the image is rotated 90-degrees or 180-degrees either clockwise or anti-clockwise (step S507). The method further comprises a display unit 47 in communication with the microprocessor 46 to provide a preview of the image on the display unit 47 after the image has been rotated. The preview step further has a confirming function for confirming that the previewed image has been aligned correctly. Finally, the image is stored on the storage medium after being realigned (step S509). Whereby, the rotating step is repeated until the image features are facing upwards in order that the correctly aligned image is stored on the storage medium.

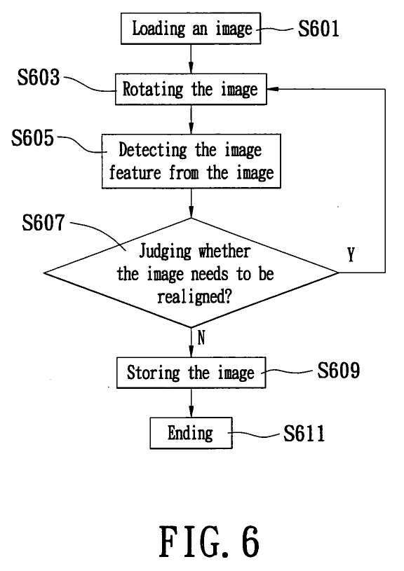

The method of the second embodiment is to rotate the image when the digital image is transmitted from the image acquisition apparatus to the storage medium. Moreover, the feature identification algorithm can be stored in the storage medium, such as a computer or a portable storage apparatus, and in the digital image acquisition apparatus as an image-processing program for a digital camera. Please refer to FIG. 6 showing a flowchart for a method of automatically rotating images according to the second embodiment of the present invention. In the second embodiment, the method comprises the steps of: firstly, loading an image from the storage medium or the image acquisition apparatus in a loading step (step S601); afterward, rotating the image in a rotating step (step S603), wherein before the rotating step, a preview of the image is provided that displays what the image will look like after the image has been rotated. The preview step further has a confirming function for confirming that the previewed image has been aligned correctly.

Thereafter, the method comprises detecting at least one image feature, such as facial features or other image features, from the image using the feature identification acquisition (step S605); judging whether the image feature is facing upwards or needs to be realigned in a judging step (step S607), wherein, if the image feature does not need to be realigned, storing the image in the storage medium and finishing the process (step S611). If the image feature is not facing upwards, returning to the rotating step S603 to rotate the image until the image is facing upwards. Whereby, the rotating step is repeated until the image is facing upwards.

In conclusion, the method of modifying an image, which is stored in the digital image acquisition apparatus or another storage medium apparatus, executes the image detecting, the image judging and the image rotating steps via the feature identification algorithm of the image realignment apparatus.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of automatically rotating images, the method comprising the steps of:
a loading step, for loading an image;
a detecting step, for detecting at least one image feature from the image;
a judging step, for judging whether the image feature is facing upwards; and
a rotating step, for rotating the image until the image feature is facing upwards.

2. The method as claimed in claim 1, further comprising returning to the judging step after a clockwise or anti-clockwise rotation of the image by 90 degrees in the rotating step.

3. The method as claimed in claim 1, wherein the rotating step directly rotates the image to make the image feature face upwards.

4. The method as claimed in claim 1, further comprising a preview step performed before the rotating step, for providing a preview of the image after the image has been rotated.

5. The method as claimed in claim 4, wherein the preview step has a confirming function for confirming that the previewed image has been aligned correctly.

6. The method as claimed in claim 1, wherein the image features include at least one facial feature selected from: eyes, eyebrows, nostrils, lips, ears and hair.

7. The method as claimed in claim 1, wherein the loading step directly loads the image from an image acquisition apparatus.

8. An image realignment apparatus comprising:
a loading unit, for loading an image;
a memory unit, for storing at least one feature identification algorithm and the image; and
a microprocessor, for detecting at least one image feature from the image according to the feature identification algorithm, judging whether the image feature is facing upwards, and rotating the image until the image feature is facing upwards.

9. The image realignment apparatus as claimed in claim 8, further comprising a display unit for display the image.

10. The image realignment apparatus as claimed in claim 9, wherein before rotating the image, communicates with the microprocessor, to provide a preview of the image on after the image has been rotated.

11. The image realignment apparatus as claimed in claim 8, wherein the loading step directly loads the image from an image acquisition apparatus.

12. A method of automatically rotating images, the method comprising the steps of:
a loading step, for loading an image;
a rotating step, for rotating the image;
a detecting step, for detecting at least one image feature from the image; and
a judging step, for judging whether the image feature is facing upwards, wherein if the image feature is not facing upwards, returning to the rotating step for rotating the image until the image feature is facing upwards.

13. The method as claimed in claim 12, wherein the rotating step rotates the image 90 degrees.

14. The method as claimed in claim 12, further comprising a preview step performed before the rotating step, for providing a preview of the image after the image has been rotated.

15. The method as claimed in claim 14, wherein the preview step has a confirming function for confirming that the previewed image has been aligned correctly.

16. The method as claimed in claim 12, wherein the loading step directly loads the image from an image acquisition apparatus.
